(19) United States
(12) Patent Application Publication
(10) Pub. No.: US 2026/0170397 A1
(43) Pub. Date: Jun. 18, 2026

(54) ADJUSTING PERSISTENT STORAGE OF CACHED MACHINE LEARNING MODELS BASED ON TRAINING DYNAMICS

(71) Applicant: Dell Products L.P., Round Rock, TX (US)

(72) Inventors: Qi Bao, Acton, MA (US); Emine Ugur Kaynar Terzioglu, Boston, MA (US); Gaurav Chawla, Austin, TX (US)

(21) Appl. No.: 18/979,263

(22) Filed: Dec. 12, 2024

(51) Int. Cl. G06N 20/00

(52) U.S. Cl. CPC G06N 20/00

(57) ABSTRACT

The technologies described herein are generally directed toward adjusting persistent storage of cached machine learning models based on training dynamics. For instance, a system can monitor a training dynamic applicable to training a machine learning model in association with a batch of training data, with the training of the machine learning model being performed by a compute processor coupled to a checkpoint cache memory, and configured to, during the training, cache a differential checkpoint of the machine learning model to the checkpoint cache memory. The system can further cache the differential checkpoint of the machine learning model to the checkpoint cache memory. Further, the system can store at a checkpoint interval, the differential checkpoint to a persistent storage device, with the checkpoint interval being based on the training dynamic.

### BACKGROUND

Modern systems that implement artificial intelligence (AI)/machine learning (ML) systems may manage multiple storage intensive operations. To improve fault tolerance, training workflows periodically save their model states for various reasons, such as handling failures, debugging models, or development purposes. In some circumstances, checkpointing may need to be adjusted to achieve system goals.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include monitoring a training dynamic applicable to training a machine learning model in association with a batch of training data, with the training of the machine learning model being performed by a compute processor coupled to a checkpoint cache memory, and the compute processor being configured to, during the training, cache a differential checkpoint of the machine learning model to the checkpoint cache memory. The method may further include caching the differential checkpoint of the machine learning model to the checkpoint cache memory. Further, the method may include storing at a checkpoint interval, the differential checkpoint to a persistent storage device, with the checkpoint interval being based on the training dynamic.

Additionally or alternatively, the training dynamic may include an ongoing input/output bandwidth of the persistent storage device. Additionally or alternatively, the training dynamic may include a measurement of storage utilization used at the persistent storage device by differential checkpoints over time. Additionally or alternatively, the training dynamic may include a magnitude of changes to checkpoint volume over time. Additionally or alternatively, the method can further include communicating, by the system, a recovery command to recover the differential checkpoint from the persistent storage device, and combining, by the system, data corresponding to the differential checkpoint received based on the recovery command with the machine learning model stored in the checkpoint cache memory.

Additionally or alternatively, the training dynamic may include a measurement of ongoing model update magnitude. Additionally or alternatively, the training dynamic includes a measurement of accumulated gradient effects over time in relation to a size of the batch of training data. Additionally or alternatively, the updated cache interval may include a longer interval based on a training dynamic that indicates stable and consistent model updates. Additionally or alternatively, the updated cache interval may include a smaller interval based on a training dynamic that indicates at least one condition selected from a group of conditions including volatile updates, deterioration of validation performance, and gradient variability higher than a predicted variability.

An example system can operate as follows. At least one memory may store computer executable instructions, and at least one processor may be configured to process the computer executable instructions that, when executed by the at least one processor, facilitate performance of operations. The operations may include receiving, from a buffer memory of a compute device, a differential snapshot of a current state of an artificial intelligence model being trained during an epoch. The operations may further include monitoring a performance metric of a storage device. The operations may further include, at a checkpoint interval based on the performance metric, storing, at the storage device, the differential snapshot. Additionally or alternatively, the performance metric may include storage throughput of the storing of differential snapshots during the epoch.

Additionally or alternatively, the performance metric may include a rate of change of a size of the differential snapshots during the epoch. Additionally or alternatively, the performance metric may include a measurement of compression ratios of the differential snapshots during the epoch. Additionally or alternatively, the operations may further include receiving a snapshot restore command to recover the differential snapshot, and combining the differential snapshot with a version of the artificial intelligence model stored in the buffer memory.

An example non-transitory machine-readable medium may include executable instructions that, when executed by at least one processor, facilitate performance of operations. The operations may include monitoring operation of a parameter adjustment engine during an adjustment of parameters of a predictive model, with the parameter adjustment engine being coupled to a memory and a storage device, and, during adjustment of parameters, the parameter adjustment engine is configured to cache a differential checkpoint of the predictive model in the memory. The operations may further include caching the differential checkpoint of the predictive model to the memory, resulting in a cached differential checkpoint. The operations may further include storing, after a number of operations, the cached differential checkpoint to a storage device, with the number of operations being based on the operation of the parameter adjustment engine.

Additionally or alternatively, the operation of the parameter adjustment engine is indicated by a performance metric received from the storage device. Additionally or alternatively, monitoring the operation of the parameter adjustment engine may include receiving, from the parameter adjustment engine, an indication that adjustment of the parameters is proceeding differently than a prediction. Additionally or alternatively, the prediction may include a prediction of validation performance, and the adjustment of the parameters proceeds with a deterioration of the validation performance below the prediction. Based on the deterioration of the validation performance, the indication to change the number of operations may include an indication to decrease the number of operations.

Additionally or alternatively, the operations further include determining to recover the data representative of the cached differential checkpoint, communicating, to the storage device, a recovery instruction. Based on the recovery instruction, combining cached data of the predictive model with the data representative of the cached differential checkpoint, and communicating the data representative of the cached differential checkpoint to the parameter adjustment engine.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate adjusting persistent storage of cached machine learning models based on training dynamics, in accordance with one or more embodiments.

FIG. 2 is an architecture diagram of an example system that can facilitate adjusting persistent storage of cached machine learning models based on training dynamics, in accordance with one or more embodiments.

FIG. 3 is an architecture diagram of an example system that can facilitate adjusting persistent storage of cached machine learning models based on training dynamics, in accordance with one or more embodiments.

FIG. 4 is an architecture diagram of an example system that can facilitate adjusting persistent storage of cached machine learning models based on training dynamics, in accordance with one or more embodiments.

FIG. 5 depicts a flow diagram representing example operations of some embodiments that can facilitate adjusting persistent storage of cached machine learning models based on training dynamics, in accordance with one or more embodiments.

FIG. 6 depicts a flow diagram representing example operations of an example method 600 that can facilitate adjusting persistent storage of cached machine learning models based on training dynamics, in accordance with one or more embodiments.

FIG. 7 depicts an example system that can facilitate adjusting persistent storage of cached machine learning models based on training dynamics, in accordance with one or more embodiments.

FIG. 8 depicts an example non-transitory machine-readable medium that can include executable instructions that, when executed by a processor of a system, can facilitate adjusting persistent storage of cached machine learning models based on training dynamics, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance of a computing system that implements and/or otherwise interacts with a large language model (LLM) or other similar machine learning model can be improved, e.g., by providing approaches to improving fault-tolerance while preserving or improving the performance of model training processes. One or more embodiments described herein provide solutions to problems of latency and performance losses that can occur when checkpointing or restoring large machine learning models. These problems become especially complex when increasingly large machine learning models are trained by multiple compute processors simultaneously. Further, it is noted that implementations described herein can provide solutions to technical problems that are inextricably tied to computer systems. For example, approaches that may analyze training dynamics in real time, and adjust different configuration settings to achieve complex multivariate solutions, improving fault-tolerances while reducing latency and performance losses in the checkpointing process. As described below, embodiments described herein utilize approaches that solve these and other technical problems with technical solutions. Moreover, implementations described herein can provide solutions to technical problems that are inextricably tied to computer systems, and provide these solutions in a manner that cannot reliably be performed by a human or even a plurality of humans, e.g., analyzing complex machine learning model training dynamics and configuring hardware settings of distributed systems so as to improve overall training performance without compromising other considerations.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

As used herein, machine learning models may also be referred to as predictive models, artificial intelligence models, or just models. Training engines that change model parameters (weights), may be termed compute processors/engines, and parameter-adjustment engines.

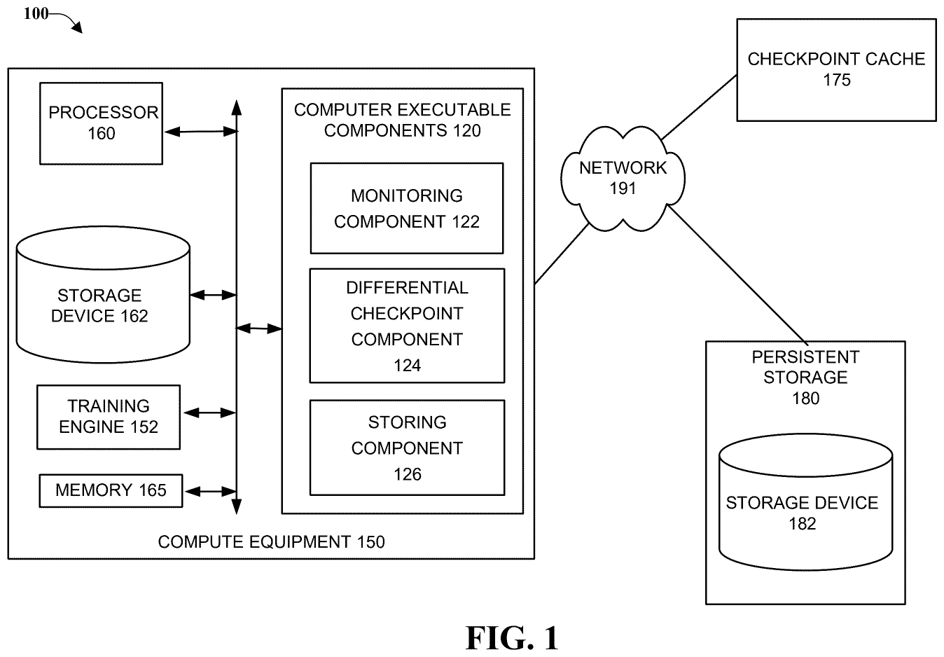

FIG. 1 is an architecture diagram of an example system 100 that can facilitate adjusting persistent storage of cached machine learning models based on training dynamics, in accordance with one or more embodiments. For purposes of brevity, description of like elements and/or processes employed in other embodiments is omitted. As depicted, system 100 includes compute equipment 150 connected, via network 191, to persistent storage 180 and checkpoint cache 175. Compute equipment includes training engine 152.

As depicted, compute equipment 150 can include memory 165 that can store one or more computer and/or machine readable, writable, and/or executable components 120 and/or instructions. In embodiments, compute equipment 150 can further include processor 160. In one or more embodiments, computer executable components 120, when executed by processor 160, can facilitate performance of operations defined by the executable component(s) and/or instruction(s). Computer executable components 120 can include monitoring component 122, differential checkpoint component 124, storing component 126, and other components described or suggested by different embodiments described herein, that can improve the operation of system 100. Compute equipment 150 may further include storage device 162. In an example, storage device 162 may provide nonvolatile storage of data, data structures, computer executable instructions, and so forth.

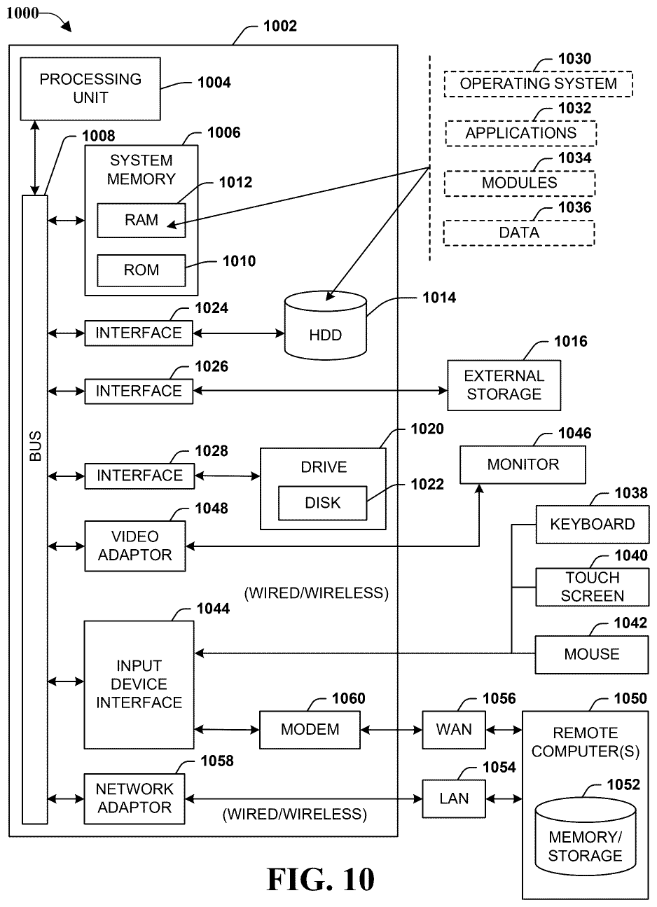

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 191 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of monitoring component 122, which can in some implementations, monitor a training dynamic applicable to training a machine learning model in association with a batch of training data, with the training of the machine learning model being performed by a compute processor coupled to a checkpoint cache memory, and the compute processor is configured to, during the training, cache a differential checkpoint of the machine learning model to the checkpoint cache memory. For example, in one or more embodiments, monitoring component 122 may monitor a training dynamic applicable to training engine 152 training a machine learning model in association with a batch of training data stored in storage device 162, with training engine 152 coupled to checkpoint cache 175, and the compute processor is configured to, during the training, cache a differential checkpoint of the machine learning model to checkpoint cache 175.

In another example, memory 165 can store executable instructions that can facilitate generation of differential checkpoint component 124, which in some implementations may cache the differential checkpoint of the machine learning model to the checkpoint cache memory. For example, in one or more embodiments, checkpoint component 124 may cache the differential checkpoint of the machine learning model to checkpoint cache 175.

In another example, memory 165 can store executable instructions that can facilitate generation of storing component 126, which in some implementations may store, at a checkpoint interval, the differential checkpoint to a persistent storage device, with the checkpoint interval being based on the training dynamic. For example, in one or more embodiments, storing component 126 may facilitate checkpoint cache 175 storing, at a checkpoint interval, the differential checkpoint to persistent storage 180, with the checkpoint interval being based on the training dynamic monitored by monitoring component 122.

It is appreciated that the embodiments of the subject disclosure depicted in various figures disclosed herein are for illustration only, and as such, the architecture of such embodiments are not limited to the systems, devices, and/or components depicted therein. For example, in some embodiments, compute equipment 150, persistent storage 180, and other devices discussed herein, can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

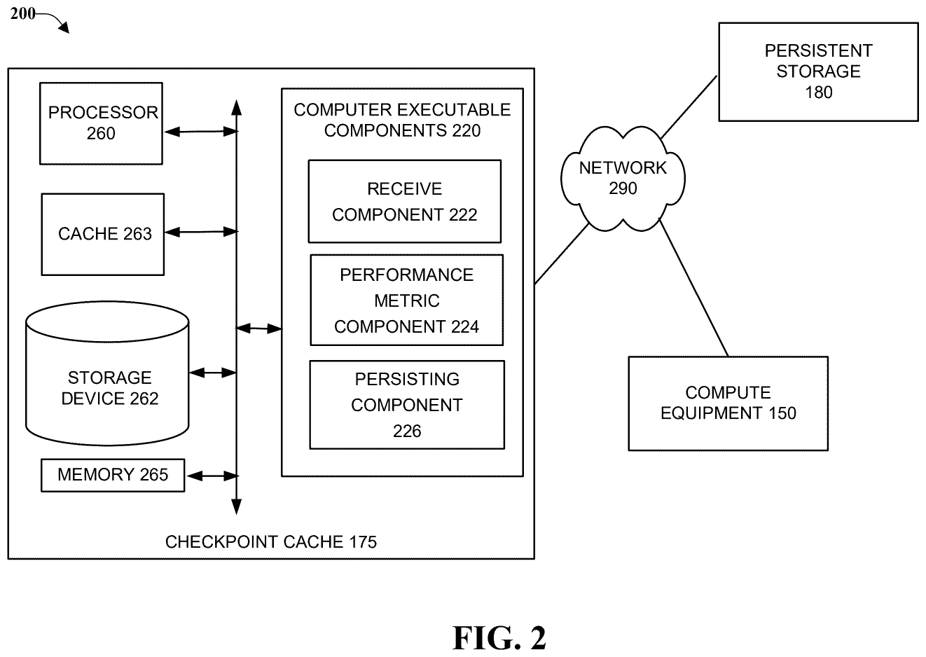

It should be noted that compute equipment 150, persistent storage 180, checkpoint cache 175, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as compute equipment 150. For example, one or more of compute equipment 150, and persistent storage 180 can all be separate subsystems running in the kernel of a computing device as well as operating on separate network equipment, e.g., as depicted in FIGS. 1 and 2.

FIG. 2 is an architecture diagram of an example system 200 that can facilitate adjusting persistent storage of cached machine learning models based on training dynamics, in accordance with one or more embodiments. For purposes of brevity, description of like elements and/or processes employed in other embodiments is omitted. As depicted, system 200 includes checkpoint cache 175 connected, via network 290, to compute equipment 150 and persistent storage 180. Checkpoint cache 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include receive component 222, performance metric component 224, and persisting component 226, and other components described or suggested by different embodiments described herein, e.g., that can improve the operation of system 200, in accordance with one or more embodiments.

In an example implementation of checkpoint cache 175, memory 265 can store executable instructions that can facilitate generation of receive component 222, which in some implementations, may receive, from a buffer memory of a compute device, a differential snapshot of a current state of an artificial intelligence model being trained during an epoch. For example, in one or more embodiments, receiving component 222, may receive, from a buffer memory 165 of compute equipment 150, a differential snapshot generated by differential checkpoint component 124 of an artificial intelligence model being trained by training engine 152 during an epoch.

In an example implementation of persistent storage 180, memory 265 can further store executable instructions that can facilitate generation of performance metric component 224, which in some implementations, may monitor a performance metric of a storage device. For example, in one or more embodiments, performance metric component 224, may monitor a performance metric of persistence storage 180 as the storage receives differential checkpoints, e.g., from checkpoint cache 175.

In an example implementation of persistent storage 180, memory 265 can further store executable instructions that can facilitate generation of persisting component 226, which in some implementations, may, at a checkpoint interval based on the performance metric, store, at the storage device, the differential snapshot. For example, in one or more embodiments, persisting component 226, may, at a checkpoint interval based on the performance metric, store, the differential snapshot stored in checkpoint cache 175 at storage device 182 of persistent storage 180.

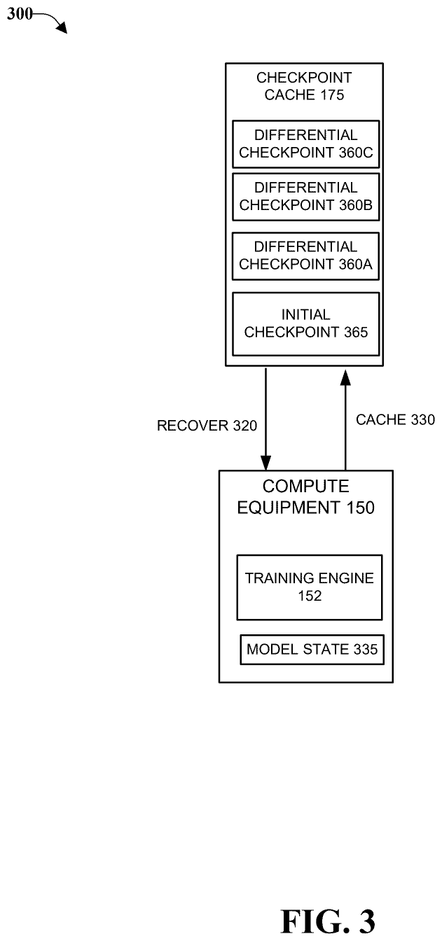

FIG. 3 is an architecture diagram of an example system 300 that can facilitate adjusting persistent storage of cached machine learning models based on training dynamics, in accordance with one or more embodiments. For purposes of brevity, description of like elements and/or processes employed in other embodiments is omitted. As depicted, system 300 includes checkpoint 175 coupled (e.g., recover 320 and cache 330) to compute equipment 150, with compute equipment 150 including training engine 152 and model state 335, and checkpoint cache 175 includes initial checkpoint 365 and differential checkpoints 360A-C.

As depicted in FIG. 3, differential checkpoint cache 175 initially received initial checkpoint 365 from compute equipment 150, e.g., this initial checkpoint including the differences from nothing initially being stored. As differential checkpoint component 124 generates differential checkpoints 360A-C, these are stored by compute equipment 150 at checkpoint cache 175.

In an embodiment, checkpoint cache 175 may issue a recover 320 command (also termed a snapshot restore command) to recover the differential checkpoint from persistent storage 180. The differential checkpoint may be combined with other, earlier differential checkpoints and initial checkpoint 365 to recover the full model from when the differential checkpoint was generated.

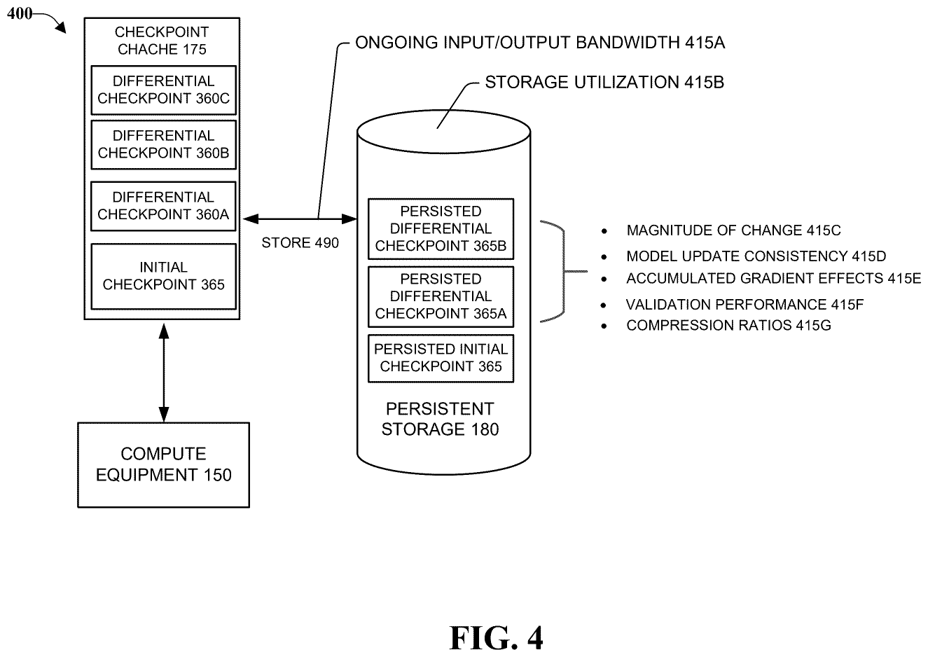

FIG. 4 is an architecture diagram of an example system 400 that can facilitate adjusting persistent storage of cached machine learning models based on training dynamics, in accordance with one or more embodiments. For purposes of brevity, description of like elements and/or processes employed in other embodiments is omitted. As depicted, system 300 includes checkpoint cache 175 coupled to compute equipment and persistent storage 180. Checkpoint cache 175 includes initial checkpoint 365 and differential checkpoints 360A-C.

In some embodiments, persisting cached checkpoints to persistent (e.g., non-volatile) storage more frequently may enhance the data durability/fault-tolerance of the machine learning model, e.g., by protecting against power losses or system crashes that could affect checkpoint cache 175. For large machine learning models that require extensive training over long periods of time, persistence may minimize recovery time and complexity by maintaining up-to-date checkpoints that may serve as reliable recovery anchors. This approach may be particularly valuable in distributed caching systems where node failures could lead to significant amounts of data reconstruction. Additionally, for machine learning systems subject to regulatory requirements, maintaining checkpoint persistence at a determined interval may support compliance with audit or regulatory requirements, e.g., providing a tamper-resistant trail of state changes and decision points.

By monitoring ongoing training dynamics during training epochs, one or more embodiments may adjust how differential checkpoints are stored. For example, in one or more embodiments, the training dynamic includes an ongoing input/output bandwidth of the persistent storage device. With respect to predicted training dynamics, when ongoing input output bandwidth 415A of the persistent storage of cached checkpoint data is slower than predicted, when storage utilization 415B is higher than predicted, operation of training engine 152 may be adjusted to improve the likelihood that model changes do not exceed the speed of the storage of the changes.

Other training dynamics that may cause one or more embodiments to increase the frequency of caching and persistent storage include, but are not limited to, ongoing magnitude of changes 415C to the machine learning model for each checkpoint, the model update consistency 415D of checkpoint changes, the accumulated gradient effects 415E of checkpoint model changes, the validation performance 415F of the machine learning model during training, and compression ratios 415G of checkpointed data.

Returning to the example of FIG. 4, as persisting component 226 asynchronously persists differential checkpoints 360A-B, these are stored at persistent storage 180 as persisted differential checkpoints 365A-B. As shown in the example of FIG. 4, differential checkpoint 360C has not yet been persisted by persisting component 226, and thus the latest differential checkpoint stored at persistent storage 180 is persisted differential checkpoint 365B.

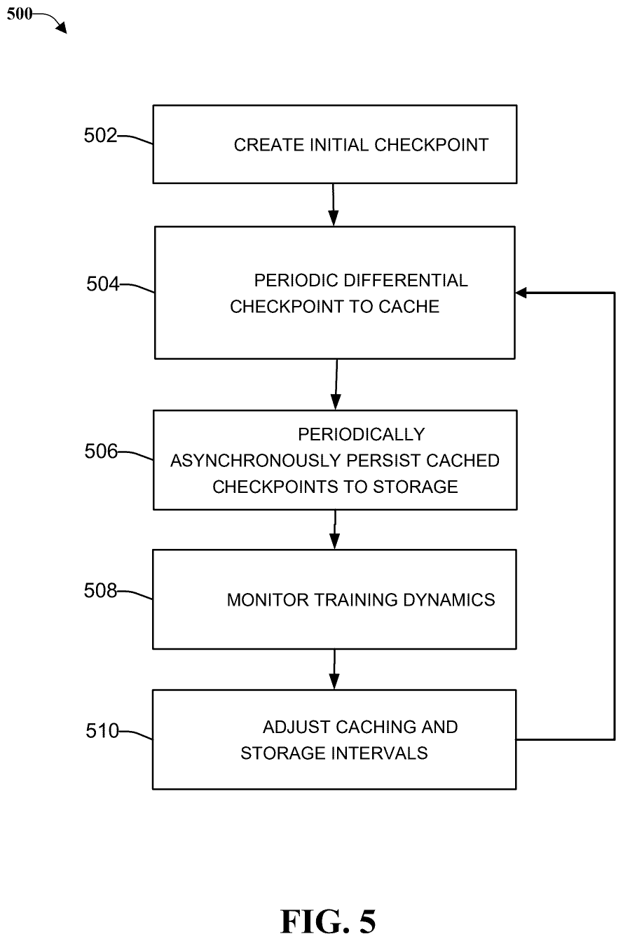

FIG. 5 depicts a flow diagram 500 representing example operations of some embodiments that can facilitate adjusting persistent storage of cached machine learning models based on training dynamics, in accordance with one or more embodiments. For purposes of brevity, description of like elements and/or processes employed in other embodiments is omitted.

At 502, in one or more embodiments, initial checkpoint 226 may be created, e.g., to provide a base model with which incremental checkpoints may be combined. At 504, during model training computations that include, but are not limited to, forward propagation, loss calculation, backpropagation, and weight updating, differential checkpoints may be periodically generated and saved to checkpoint cache 175. At 506, asynchronously to the operation of training engine 152, the checkpoint data cached in checkpoint cache 175 may be periodically stored 490 to persistent storage 180, e.g., as protection against a failure of checkpoint cache 175.

At 508, the training dynamics of the training epoch may be monitored to assess factors that may be relevant to the frequency of checkpoint caching and cached checkpoint persisting. The dynamics listed above are non-limiting, with other, similar metrics also being useful for embodiments to monitor and analyze. At 510, based on analysis of the training dynamics, caching and persistence intervals may be adjusted to achieve goals including improved fault tolerance. As depicted, operation of embodiments may loop back to 504, for the implementation of the adjustments during the ongoing training operations.

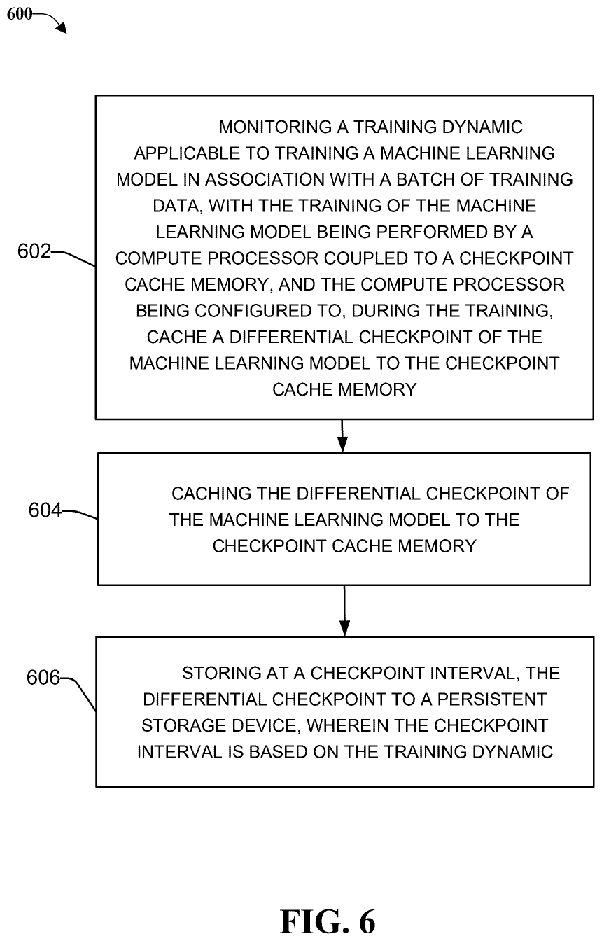

FIG. 6 depicts a flow diagram representing example operations of an example method 600 that can facilitate adjusting persistent storage of cached machine learning models based on training dynamics, in accordance with one or more embodiments. For purposes of brevity, description of like elements and/or processes employed in other embodiments is omitted.

In some examples, one or more embodiments of method 600 can be implemented by monitoring component 122, differential checkpoint component 124, storing component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, monitoring component 122 of compute equipment 150 can, in one or more embodiments, monitor a training dynamic applicable to training a machine learning model in association with a batch of training data, with the training of the machine learning model being performed by a compute processor coupled to a checkpoint cache memory, and the compute processor being configured to, during the training, cache a differential checkpoint of the machine learning model to the checkpoint cache memory.

At 604 of method 600, differential checkpoint component 124 of compute equipment 150 can, in one or more embodiments, cache the differential checkpoint of the machine learning model to the checkpoint cache memory. At 606 of method 600, storing component 126 of compute equipment 150 can, in one or more embodiments, store at a checkpoint interval, the differential checkpoint to a persistent storage device, wherein the checkpoint interval is based on the training dynamic.

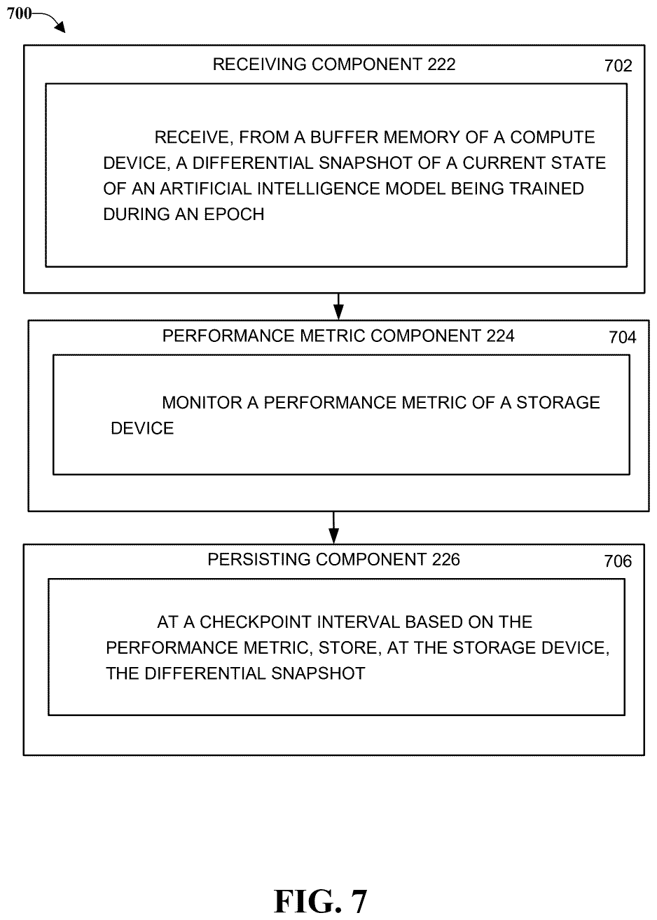

FIG. 7 depicts an example system 700 that can facilitate adjusting persistent storage of cached machine learning models based on training dynamics, in accordance with one or more embodiments. For purposes of brevity, description of like elements and/or processes employed in other embodiments is omitted.

Example system 700 can include receive component 222, performance metric component 224, persisting component 226, and other components that can be used to implement aspects of system 700, as described herein, in accordance with one or more embodiments.

At 702 of FIG. 7, receive component 222 can receive, from a buffer memory of a compute device, a differential snapshot of a current state of an artificial intelligence model being trained during an epoch. At 704 of FIG. 7, performance metric component 224 can monitor a performance metric of a storage device. At 706 of FIG. 7, persisting component 226 can at a checkpoint interval based on the performance metric, store, at the storage device, the differential snapshot.

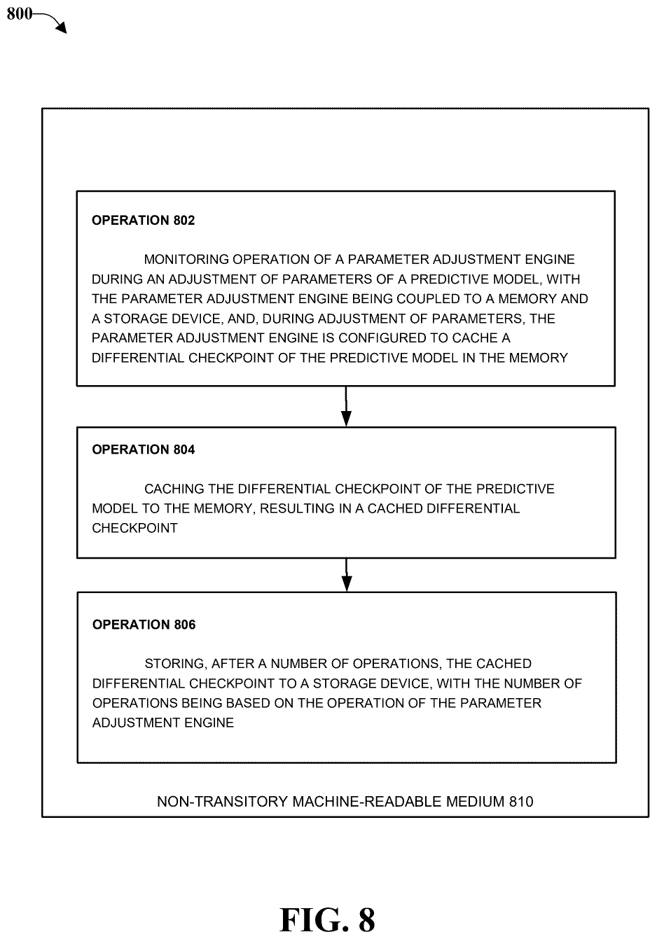

FIG. 8 depicts an example 800 non-transitory machine-readable medium 810 that can include executable instructions that, when executed by a processor of a system, can facilitate adjusting persistent storage of cached machine learning models based on training dynamics, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which includes monitoring operation of a parameter adjustment engine during an adjustment of parameters of a predictive model, with the parameter adjustment engine being coupled to a memory and a storage device, and, during adjustment of parameters, the parameter adjustment engine is configured to cache a differential checkpoint of the predictive model in the memory.

Operation 804 includes caching the differential checkpoint of the predictive model to the memory, resulting in a cached differential checkpoint. Operation 806 includes storing, after a number of operations, the cached differential checkpoint to a storage device, with the number of operations being based on the operation of the parameter adjustment engine.

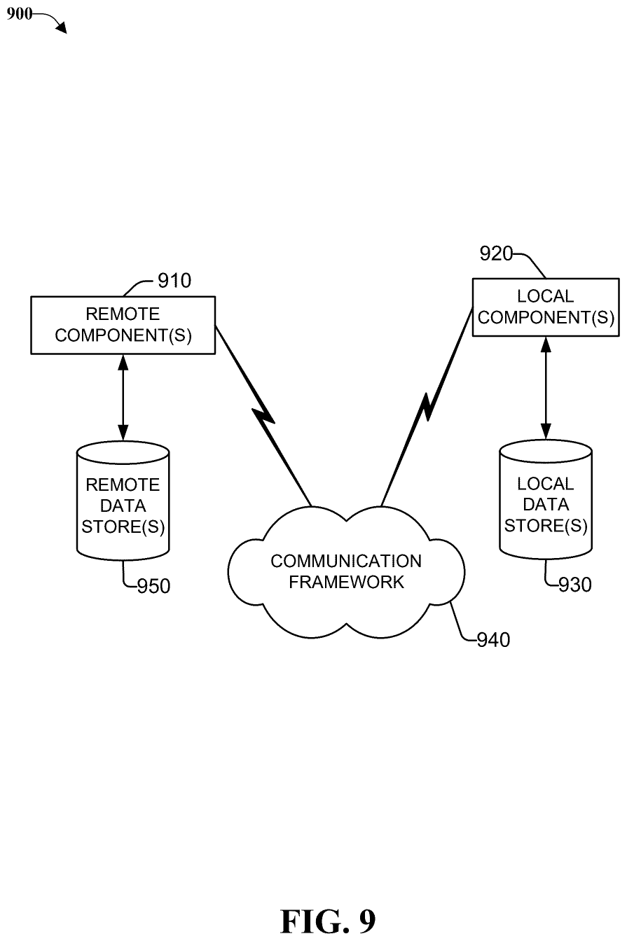

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
monitoring, by a system comprising one or more processors, a training dynamic applicable to training a machine learning model in association with a batch of training data, wherein the training of the machine learning model is performed by a compute processor coupled to a checkpoint cache memory, and wherein the compute processor is configured to, during the training, cache a differential checkpoint of the machine learning model to the checkpoint cache memory;
caching, by the system, the differential checkpoint of the machine learning model to the checkpoint cache memory; and
storing, by the system, at a checkpoint interval, the differential checkpoint to a persistent storage device, wherein the checkpoint interval is based on the training dynamic.

2. The method of claim 1, further comprising, based on the monitoring of the training dynamic, adjusting, by the system, the checkpoint interval, resulting in an updated checkpoint interval.

3. The method of claim 2, wherein the updated checkpoint interval comprises a longer interval based on the training dynamic indicating stable and consistent model updates.

4. The method of claim 2, wherein the updated checkpoint interval comprises a smaller interval based on the training dynamic indicating at least one condition selected from a group of conditions comprising volatile updates, deterioration of validation performance, and gradient variability higher than a predicted variability.

5. The method of claim 1, wherein the training dynamic comprises an ongoing input/output bandwidth of the persistent storage device.

6. The method of claim 1, wherein the training dynamic comprises a measurement of storage utilization used at the persistent storage device by differential checkpoints over time.

7. The method of claim 1, wherein the training dynamic comprises a magnitude of changes to checkpoint volume over time.

8. The method of claim 1, further comprising:
communicating, by the system, a recovery command to recover the differential checkpoint from the persistent storage device; and
combining, by the system, data corresponding to the differential checkpoint received based on the recovery command with the machine learning model stored in the checkpoint cache memory.

9. The method of claim 1, wherein the training dynamic comprises a measurement of ongoing model update magnitude.

10. The method of claim 1, wherein the training dynamic comprises a measurement of accumulated gradient effects over time in relation to a size of the batch of training data.

11. A computing system, comprising:
at least one memory that stores computer executable instructions; and
at least one processor configured to process the computer executable instructions that, when executed by the at least one processor, facilitate performance of operations, comprising:
receiving, from a buffer memory of a compute device, a differential snapshot of a current state of an artificial intelligence model being trained during an epoch,
monitoring a performance metric of a storage device, and
at a checkpoint interval based on the performance metric, storing, at the storage device, the differential snapshot.

12. The computing system of claim 11, wherein the performance metric comprises storage throughput of the storing of differential snapshots during the epoch.

13. The computing system of claim 11, wherein the performance metric comprises a rate of change of a size of the differential snapshots during the epoch.

14. The computing system of claim 11, wherein the performance metric comprises a measurement of compression ratios of the differential snapshots during the epoch.

15. The computing system of claim 11, wherein the operations further comprise:
receiving a snapshot restore command to recover the differential snapshot; and
combining the differential snapshot with a version of the artificial intelligence model stored in the buffer memory.

16. A non-transitory machine-readable medium comprising executable instructions that, when executed by at least one processor of a machine learning device, facilitate performance of operations, the operations comprising:
monitoring operation of a parameter adjustment engine during an adjustment of parameters of a predictive model, wherein the parameter adjustment engine is coupled to a memory and a storage device, and wherein, during adjustment of parameters, the parameter adjustment engine is configured to cache a differential checkpoint of the predictive model in the memory;
caching the differential checkpoint of the predictive model to the memory, resulting in a cached differential checkpoint; and
storing, after a number of operations, the cached differential checkpoint to a storage device, wherein the number of operations is based on the operation of the parameter adjustment engine.

17. The non-transitory machine-readable medium of claim 16, wherein the operation of the parameter adjustment engine is indicated by a performance metric received from the storage device.

18. The non-transitory machine-readable medium of claim 16, wherein monitoring the operation of the parameter adjustment engine comprises receiving, from the parameter adjustment engine, an indication that adjustment of the parameters is proceeding differently than a prediction.

19. The non-transitory machine-readable medium of claim 18, wherein the prediction comprises a prediction of validation performance, wherein the adjustment of the parameters is to proceed with a deterioration of the validation performance below the prediction, and wherein, based on the deterioration of the validation performance, the indication to change the number of operations comprises an indication to decrease the number of operations.

20. The non-transitory machine-readable medium of claim 16, wherein the operations further comprise:
determining to recover the data representative of the cached differential checkpoint;
communicating, to the storage device, a recovery instruction;
based on the recovery instruction, combining cached data of the predictive model with the data representative of the cached differential checkpoint; and
communicating the data representative of the cached differential checkpoint to the parameter adjustment engine.
